(19) United States
(12) Patent Application Publication
(10) Pub. No.: US 2009/0226701 A1
(43) Pub. Date: Sep. 10, 2009

(54) Boiling Enhancement Coating Produced Using Viscous Bulking Agent to Create Voids

(76) Inventor: Mark Charles Carbone, Cupertino, CA (US)

Correspondence Address: TRAN & ASSOCIATES, 6768 MEADOW VISTA CT., SAN JOSE, CA, 95135, US

(21) Appl. No.: 11/844,812

(22) Filed: Aug. 24, 2007

(51) Int. Cl. B32B 3/26; C09K 5/14; B23K 31/00

(52) U.S. Cl. 428/317.1; 252/67; 228/248.1

(57) ABSTRACT

A boiling enhancement surface is created using particles of various sizes in conjunction with a thermally conductive binder and a viscous bulking agent.

The present invention relates to boiling heat transfer from a surface to a liquid, particularly with surface enhancements to increase the density of boiling nucleation sites.

### BACKGROUND OF INVENTION

Various surface enhancement techniques have been previously investigated by researchers to augment nucleate boiling heat transfer coefficient and to extend the critical heat flux (CHF, or the highest heat flux that can be removed without exposing the surface to film boiling), and the techniques have been commercialized to maximize boiling heat transfer performance. Commercial surfaces for boiling enhancement include different types of cavities or grooves such as Furukawa's ECR-40, Wieland's GEWA, Union Carbide's High-Flux, Hitachi's Thermoexcel, and Wolverine's Turbo-B. The surface enhancement techniques are to increase vapor/gas entrapment volume and thus to increase active nucleation site density.

One of the recent methods suggested by You and O'Connor (1998) to produce an enhanced boiling surface microstructure was microporous surface structures. The microporous coating has developed into an enhancement technique that is benign enough to apply directly to electronic chip surfaces. The microporous coating provides a significant enhancement of nucleate boiling heat transfer and CHF while reducing incipient wall superheat hysteresis. One option of the microporous coating is ABM coating technique developed by You and O'Connor (1998) (U.S. Pat. No. 5,814,392). The coating is named from the initial letters of their three components (Aluminum/Devcon Brushable Ceramic/Methyl-Ethyl-Keytone). After the carrier (M.E.K.) evaporates, the resulting coated layer consists of microporous structures with aluminum particles (1 to 20 μm) and a glue (Omegabond 101 or Devcon Brushable Ceramic) having a thickness of ≈50 μm, which was shown as an optimum thickness for FC-72. The boiling heat transfer advantages of the non-conducting microporous coating method can be improved by replacing the non-thermally conducting glue with a thermally conducting binder.

The microporous surfaces can be thermally conducting when sintering process is used and the sintered surfaces are known to generate highly effective porous surface for boiling heat transfer; however it is known to be an expensive and sensitive process which requires extremely high operating temperatures. There exists a need for a porous surface with a thermally conductive binder that can be produced inexpensively and easily.

### SUMMARY

In one aspect, a composition includes one or more thermally conductive particles; a thermally conductive metal binder adapted to receive the thermally conductive particles; and a viscous bulking agent coupled to the metal binder.

Implementations of the above aspect may include one or more of the following. The binder can be applied to an electronic component surface. A flux can be applied to the electronic component surface before soldering, wherein the flux is removed after soldering application to the electronic component surface.

In another aspect, a method of coating a surface to enhance boiling properties of the surface includes creating a mixture comprising cavity-generating particles, a thermally conductive binder, and a viscous bulking agent; applying a layer of the mixture to a target surface; and heating the target surface, whereby the thermally conductive binder is melted.

Implementations of the above aspect may include one or more of the following. The method includes applying the layer to the target surface by spraying, screening, or squeegeeing. The mixture can be mixed using an ultrasonic bath. The bulking agent can be zinc chloride containing flux, comprising cleaning the target surface after melting the solder. The target surface can be an electronic component.

In a further aspect, a composition includes cavity generating particles, a binder, and a viscous bulking carrier, wherein the particle to binder ratio being about 5 grams to 0.8 grams and the carrier being about 1.2 gram per gram of particles.

Implementations of the above aspect may include one or more of the following. The viscous bulking agent can include solder flux. The binder can be solder. The cavity generating particles are selected from one of: nickel, copper, aluminum, silver, iron, brass and alloys. The cavity generating particles can be approximately 8 to approximately 30 μm in size, approximately 30 to approximately 100 μm in size, or approximately 100 to approximately 200 μm in size.

In yet another aspect, a composition of matter includes a carrier, a binder, and cavity generating particles, wherein said composition of matter contains, in relative proportion: about 1.2 gram carrier; about 0.8 grams binder; and about 1 gram of cavity generating particles.

Implementations of the above aspect may include one or more of the following. The carrier can be solder flux. The binder can be premixed solder paste. The cavity generating particles can be one of: nickel, copper, aluminum, silver, iron, brass and alloys. The cavity generating particles comprise approximately 8-30 μm in size, approximately 30-100 μm in size, or approximately 100-200 μm in size.

In another aspect, a method for surface enhancement increases heat transfer of a surface in contact with a liquid by applying to a surface the composition discussed above. The composition is applied to the surface of an electronic chip.

In another aspect, an object to be immersed in a liquid coolant includes a surface comprising a porous surface affixed by a binder; and boiling nucleation sites formed in a density increasing critical heat flux of the surface.

Implementations of the above aspect may include one or more of the following. The cavity generating particles can be one of: nickel, copper, aluminum, silver, iron, brass and alloys. The cavity generating particles can be approximately 8-30 μm in size, approximately 30-100 μm in size, or approximately 100-200 μm in size. The object can be a microelectronic component or a silicon chip. The liquid coolant can be one of: methanol, ethanol, fluorocarbons, water and FC-72. The viscous bulking agent can be solder flux. The target surface can be an electronic component.

The above systems and methods combine the advantages of low manufacturing cost with increased density of nucleation sites on a surface and high thermal conductivity from the base substrate through the coating to enhance boiling. The surface is also relatively insensitive to coating thickness due to the high thermal conductivity of the binder. In the various embodiments of the invention, the coated surface is created using particles of various sizes comprising nickel, copper, aluminum, silver, iron, brass and various alloys in conjunction with a thermally conductive binder which is put in place while mixed with a viscous bulking agent to correctly space the particles to create the desired size voids and pores. The boiling performance of the current invention, Boiling Enhancement Coating Produced Using Viscous Bulking Agent to Create Voids, is similar to the performance of other boiling enhanced surfaces.

Other advantages including a scalable mass production spray application of the coating. Other application techniques such as screening or squeegeeing the coating onto a substrate can be used. The coating process is an inexpensive and easy process which can quickly, repeatably, and uniformly coat surfaces. The disclosed coating technique is efficient for various types of working liquids simply by changing the size of metal particle sizes and the volume of bulking agent present since different surface tension of liquids requires different size range of porous cavities to optimize boiling heat transfer performance. In one embodiment, the coating is applied to an electronic component surface.

### BRIEF DESCRIPTION OF DRAWINGS

FIG. 1 shows a wet uncured coating with large discrete binder particles.

FIG. 2 shows the coating of FIG. 1 after heating to reflow the binder particles.

FIG. 3 shows the final coating of FIG. 1 after reflow and cleaning.

FIG. 4 shows an exemplary cooling chamber.

FIG. 5 shows another exemplary cooling chamber.

### DESCRIPTION

The following embodiments are included to demonstrate preferred embodiments of the invention. It should be appreciated by those of skill in the art that the techniques disclosed in the examples which follow represent techniques discovered by the inventors to function well in the practice of the invention, and thus to constitute the more preferred known modes for its practice. However, those of skill in the art should, in light of the present disclosure, appreciate that many changes can be made in the specific embodiments which are disclosed and still obtain a like or similar result without departing from the spirit and scope of the invention.

FIG. 1 shows a wet uncured coating with conductive particles 1 such as metal spheres and discrete binder particles 2 mixed in flux 3 resting above a substrate 4. One embodiment includes the use of metal particles 1 to create the base of the coating, solder particles as the binder material 2, and solder flux 3 as the bulking agent. The use of solder flux for the bulking agent accomplishes both the chemical preparation of the materials for joining as well as the creation of the voids in the coating that will serve as the boiling enhancement features. The coating system and methods provide an improvement from other pore-producing coatings, whether they use a non-thermally conducting glue to bind cavity-generating particles or a high conductivity binder such as solder. The other pore-generating coatings that use solder as the binder rely on a solvent for their fabrication. The solvent causes spaces to form between the particles of the coating when the coating material is applied to the surface to be treated. The solvent is then evaporated off and this tends to create spaces between the particles.

In the Boiling Enhancement Coating Produced Using Viscous Bulking Agent to Create Voids, the voids which become the nucleation sites are created by using a viscous bulk material, such as solder flux 3, to create the cavities. The flux 3 fills the spaces between particles 1-2 and adds dimension and volume to the coating. The flux 3 is present during firing or reflow of the coating, so it is better able to maintain control of the geometry being produced. After reflow, the flux 3 is washed away by conventional means, leaving the binders 1 above the substrate 4. In coatings that rely on solvent, the particles can move and settle into different locations as the solvent evaporates, resulting in less control over the surface being created.

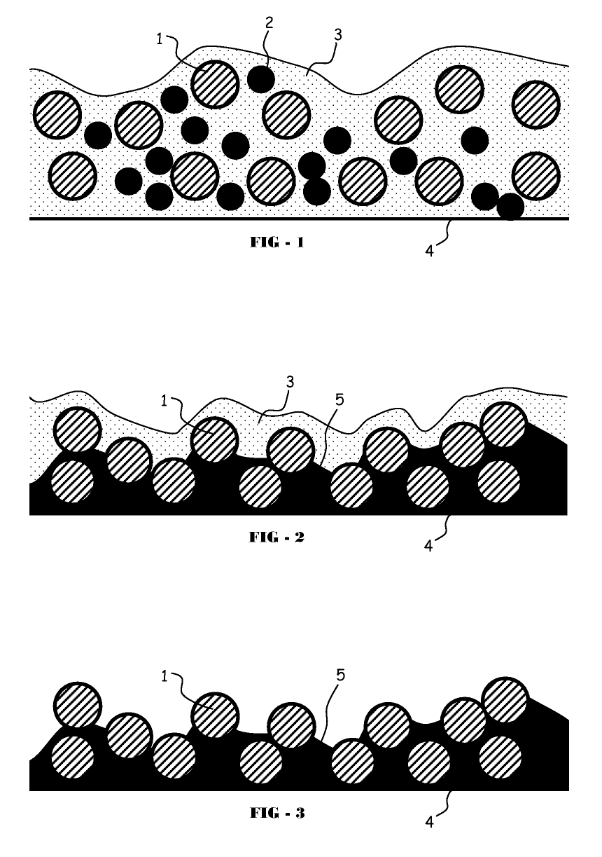

FIG. 2 shows the coating of FIG. 1 after heating to reflow the binder particles 1. In FIG. 2, the binder particles are melted and become layer 5. FIG. 3 shows the final coating of FIG. 1 after reflow, removal of the flux 3, and cleaning to leave the conductive particles 1 embedded in the melted binder layer 5 above substrate 4.

Different liquids have different surface tensions and require different size ranges of porous cavities to optimize boiling heat transfer performance. The geometry of the cavities formed using the viscous bulking agent can be varied not only be varying the size of the conductive particles and the proportion of binder present, but also by varying the amount of binding agent added to the formula. Higher amounts of viscous binding agent will cause a population of voids with larger volumes, and lower flux amounts will cause smaller voids. Void size can therefore be directly tailored to the needs of the application. Different void sizes are known to optimize the coated surface for different boiling aspects, such as boiling incipience at lower heat fluxes and higher Critical Heat Flux (CHF), the maximum power the coating can effectively handle. Larger size cavities can be constructed in the coating structures for poorly wetting fluids (such as water) without causing serious degradation of boiling enhancement. Therefore, this coating technique can be better tailored for various types of working liquids by changing the bulking agent content as well as metal particle sizes.

The coating is created using particles of various sizes comprising any conductive material which can be bonded by the soldering process, including nickel, copper, aluminum, silver, iron, brass, ceramics, and various alloys in conjunction with a thermally conductive binder and a bulking agent that spaces the particles during fabrication and is then removed prior to use to reveal voids. These voids are the surface enhancement that promotes boiling.

The method of applying the coating described to a surface includes creating a uniform mixture of the cavity-generating particles 1, the thermally conductive binder 2, and the viscous bulking agent 3. The mixture can be thinned slightly as required to facilitate application, and it is then applied to the surface by spraying, screening, squeegeeing or other methods known in the art. The surface is then heated to a temperature sufficient to melt the solder paste such that it serves as a binder between the cavity generating particles.

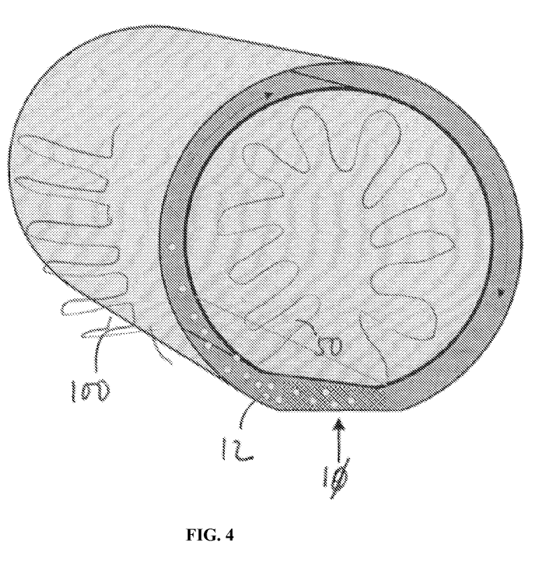

FIG. 4 shows an exemplary cooling chamber. In this chamber, a substantially cylindrical chamber is shown. The chamber has a plurality of inner heat dissipating fins 50 and a plurality of outer heat dissipating fins. In one embodiment, the cylindrical chamber has a substantially angled flat portion that encourages bubbles to form and to circulate in the chamber in a predetermined direction to maximize heat transfer. A coating 10 is positioned below the flat region and collects heat from a heat generating device. Bubbles formed as a result of heat is encouraged by the angled flat portion to bubble up from one side of the chamber and circulate to the other side of the chamber where the liquid is cooled and is reheated by the coating 10. A heat sink is coupled to the coating 10 and uses boiling to remove heat from a surface. The microporous coating such as those in FIGS. 1-3 reduces wall superheat to enhance boiling at the surface. The heat sink has a cylindrical shape to facilitate circulation of the liquid. Buoyancy provides the driving force for the liquid circulation. A constricted area on one side of the heated area shunts the bubbles in one direction even if the heat source is horizontal. Overall heat transfer is enhanced by the circulation. Extended surfaces for heat transfer to air can be placed on the inside and or the outside of the cylinder.

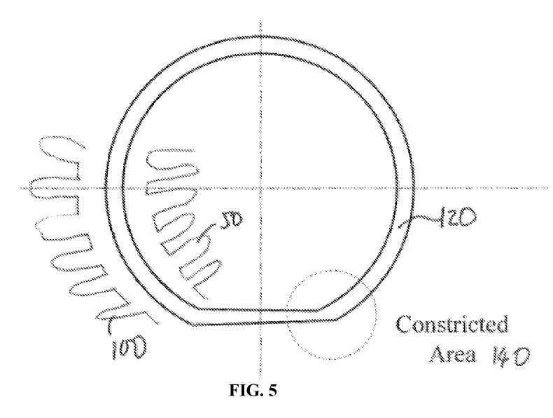

FIG. 5 shows another exemplary cooling chamber. In this chamber, the cylindrical chamber 120 has a constricted area 140 which encourages bubbles to form and circulate in a predetermined direction in the chamber to maximize heat transfer. In one embodiment, the constricted area is lower than the unconstructed area to encourage a unidirectional bubble circulation process. The coating 10 is positioned below the flat region and collects heat from a heat generating device. Bubbles formed as a result of heat is encouraged by the angled flat portion to bubble up from one side of the chamber and circulate to the other side of the chamber where the liquid is cooled and is reheated by the coating 10.

Other variations and embodiments are possible in light of above teachings, and it is thus intended that the scope of invention not be limited by this Detailed Description, but rather by the following claims.

What is claimed is:

1. A composition, comprising:
one or more thermally conductive particles;
a thermally conductive metal binder adapted to receive the thermally conductive particles; and
a viscous bulking agent coupled to the metal binder.

2. The composition of claim 1, wherein the binder is applied to an electronic component surface.

3. The composition of claim 2, comprising a flux applied to the electronic component surface before soldering, wherein the flux is removed after soldering application to the electronic component surface.

4. A method of coating a surface to enhance boiling properties of the surface comprising:
creating a mixture comprising cavity-generating particles, a thermally conductive binder, and a viscous bulking agent;
applying a layer of the mixture to a target surface; and
heating the target surface, whereby the thermally conductive binder is melted.

5. The method of claim 4, comprising applying the layer to the target surface by one of: spraying, screening, squeegeeing.

6. The method of claim 4, comprising mixing the mixture using an ultrasonic bath.

7. The method of claim 4, wherein the bulking agent comprises flux, comprising cleaning the target surface after melting the solder.

8. The method of claim 4, wherein the target surface comprises an electronic component.

9. A composition comprising cavity generating particles, a binder, and a viscous bulking carrier, wherein the particle to binder ratio being about 5 grams to 0.8 grams and the carrier being about 1.2 gram per gram of particles.

10. The composition of claim 9, wherein the viscous bulking agent comprises solder flux.

11. The composition of claim 9, wherein the binder comprises solder.

12. The composition of claim 9, wherein the cavity generating particles are selected from one of: nickel, copper, aluminum, silver, iron, brass and alloys.

13. The composition of claim 9, wherein the cavity generating particles comprise approximately 8 to approximately 30 μm in size.

14. The composition of claim 9, wherein the cavity generating particles comprise approximately 30 to approximately 100 μm in size.

15. The composition of claim 9, wherein the cavity generating particles comprise approximately 100 to approximately 200 μm in size.

16. A composition of matter comprising carrier, binder, and cavity generating particles, wherein said composition of matter contains, in relative proportion:
about 1.2 gram carrier;
about 0.8 grams binder; and
about 1 gram of cavity generating particles.

17. The composition of claim 16, wherein the carrier comprises solder flux.

18. The composition of claim 16, wherein the binder comprises premixed solder paste.

19. The composition of claim 16, wherein the cavity generating particles are selected from one of: nickel, copper, aluminum, silver, iron, brass and alloys.

20. The composition of claim 16, wherein the cavity generating particles comprise approximately 8-30 μm in size.

21. The composition of claim 16, wherein the cavity generating particles comprise approximately 30-100 μm in size.

22. The composition of claim 16, wherein the cavity generating particles comprise approximately 100-200 μm in size.

23. A method for surface enhancement to increase heat transfer of a surface in contact with a liquid, the method comprising applying to a surface the composition of claim 1.

24. The method of claim 23, wherein the composition is applied to the surface of an electronic chip.

25. An object to be immersed in a liquid coolant, comprising:
a surface comprising a porous surface affixed by a binder; and
boiling nucleation sites formed in a density increasing critical heat flux of the surface.

26. The object of claim 25, wherein the cavity generating particles comprise one of: nickel, copper, aluminum, silver, iron, brass and alloys.

27. The object of claim 25, wherein the cavity generating particles comprise approximately 8-30 μm in size.

28. The object of claim 25, wherein the cavity generating particles comprise approximately 30-100 μm in size.

29. The object of claim 25, wherein the cavity generating particles comprise approximately 100-200 μm in size.

30. The object of claim 25, wherein the object comprises a microelectronic component.

31. The object of claim 25, wherein the object comprises a silicon chip.

32. The object of claim 25, wherein the liquid coolant comprises one of: methanol, ethanol, fluorocarbons, water and FC-72.

33. The composition of claim 1, wherein the viscous bulking agent comprises solder flux.

34. The composition of claim 33, wherein the target surface comprises an electronic component.
